(19) United States
(12) Patent Application Publication
(10) Pub. No.: US 2009/0048880 A1
(43) Pub. Date: Feb. 19, 2009

(54) METHOD AND SYSTEM FOR AN ENTERPRISE MANAGEMENT SYSTEM

(76) Inventor: Itzhak SHOSHAN, Tel Aviv (IL)

Correspondence Address: SAP AG, 3410 HILLVIEW AVENUE, PALO ALTO, CA, 94304, US

(21) Appl. No.: 11/837,550

(22) Filed: Aug. 13, 2007

(51) Int. Cl. G06F 9/44

(52) U.S. Cl. 705/7

(57) ABSTRACT

Disclosed is a method and system for receiving data from an enterprise application of an enterprise, converting the data into enterprise data based on an enterprise blueprint. The enterprise data is analyzed based on the enterprise blueprint to determine a state of the enterprise and an activity to be performed is determined based on the state of the enterprise.

### FIELD OF THE INVENTION

The invention relates to the field of enterprise resource planning and more particularly to an enterprise management system.

### BACKGROUND OF THE INVENTION

Managing a business enterprise is often a challenging task. The challenge may be even bigger if the enterprise is spread globally and if the enterprise offers various products and services. It typically becomes more and more challenging to manage an enterprise efficiently as the enterprise grows in terms of factors such as revenue, number of employees, and number of locations worldwide. As the enterprise grows, if the management system does not grow with the enterprise it typically becomes difficult to manage the enterprise efficiently. The management system often involves only people managing the enterprise and no information technology applications are used to aid people managing the enterprise. People in the board of the enterprise often define enterprise parameters such as vision, objectives, and goals of the enterprise based on their gut feeling. People under the board then decide the business processes to be followed, as well as technical capabilities, information capabilities and application capabilities of the enterprise. It may become difficult and sometimes impossible for people in management to verify whether the business processes followed in the enterprise are in line with enterprise objectives and goals. It becomes difficult to analyze the business processes followed in the enterprise, considering the complexity in operating the enterprise spread over various locations, especially if the enterprise is running under a loss. Hence, managing an enterprise just by relying on human effort may be inefficient. Since the market trend is always changing, complexity is higher, rate of change is constantly increasing, and there is huge amount of data without a holistic view, managing the enterprise on a gut feeling of a human being may lead to consequences such as the management making decisions that carry high risks and low efficiency of the enterprise.

Capabilities for forecasting business opportunities, simulating the state of the enterprise in a particular condition of the market are some factors which may not be possible to be achieved by the gut feeling of a human being. A clear assessment of an effect on the state of the enterprise in different external conditions such as varying market prices of oil, varying interest rates on loan, and depending on an enterprise which may file for bankruptcy may not be possible to be achieved by a gut feeling of the human being.

### SUMMARY OF THE INVENTION

What is described is a method and system for receiving data from an enterprise application of an enterprise, converting the data into enterprise data based on an enterprise blueprint. The enterprise data is analyzed based on the enterprise blueprint to determine a state of the enterprise and an activity to be performed is determined based on the state of the enterprise.

### BRIEF DESCRIPTION OF THE DRAWINGS

FIG. 1 is a flow diagram for managing an enterprise according to an embodiment of the invention.

FIG. 2 is a flow diagram for converting the data into enterprise data according to an embodiment of the invention.

FIG. 3 is a flow diagram for analyzing the enterprise data based on the enterprise blueprint to determine a state of the enterprise according to an embodiment of the invention.

FIG. 4 is a flow diagram for determining an activity to be performed based on a state of an enterprise according to an embodiment of the invention.

FIG. 5 is a block diagram of an enterprise blueprint according to an embodiment of the invention.

FIG. 6 is a block diagram of an enterprise management system to determine an activity to be performed based on the state of the enterprise according to an embodiment of the invention.

FIG. 7 is a block diagram of an example business scenario executed in an enterprise management system according to an embodiment of the invention.

FIG. 8 is a block diagram illustrating various components of a system for managing an enterprise according to an embodiment of the invention.

### DETAILED DESCRIPTION

What is described is a method and system for receiving data from an enterprise application of an enterprise, converting the data into enterprise data based on an enterprise blueprint. The enterprise data is analyzed based on the enterprise blueprint to determine a state of the enterprise and an activity to be performed is determined based on the state of the enterprise. A report is generated containing a result of an analysis of the enterprise data that enables a user to determine the activity to be performed based on the state of the enterprise.

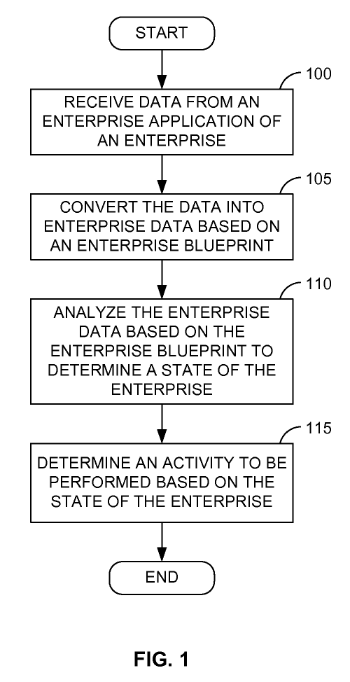

FIG. 1 is a flow diagram for managing an enterprise according to an embodiment of the invention. At step 100, data is received from an enterprise application of an enterprise. The enterprise application is an application such as a customer relationship management application, a supplier relationship management application, a supply chain management application, a finance application, and an enterprise resource planning application. At step 105, the data is converted to enterprise data based on an enterprise blueprint. The enterprise blueprint defines a business model of the enterprise.

At step 110, the enterprise data is analyzed based on the enterprise blueprint to determine a state of the enterprise. The state of the enterprise may be characterized by a business attribute such as a net profit of the enterprise, a net loss of the enterprise, an operational expenditure of the enterprise, an operational stability of the enterprise, production capability of the enterprise vs. actual production, and an effect of a market change on the enterprise. At 115, an activity to be performed is determined based on the state of the enterprise.

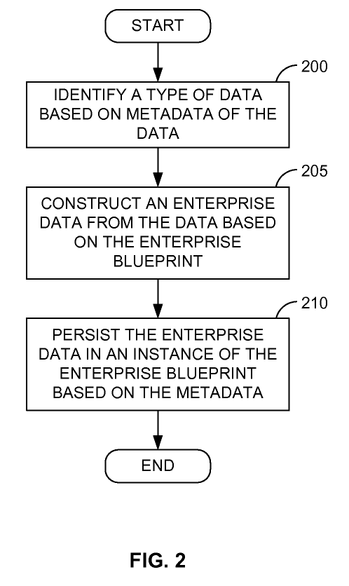

FIG. 2 is a flow diagram for converting the data into enterprise data according to an embodiment of the invention. At step 200, a type of the data is identified based on a metadata of the data. The metadata of the data includes attributes such as an enterprise application identifier, a business process identifier, a business process step identifier, an input data to the business process and an output data of the business process. At step 205, the enterprise data is constructed from the data into a structure based on the enterprise blueprint. At step 210, the enterprise data is persisted in an instance of the enterprise blueprint based on the metadata.

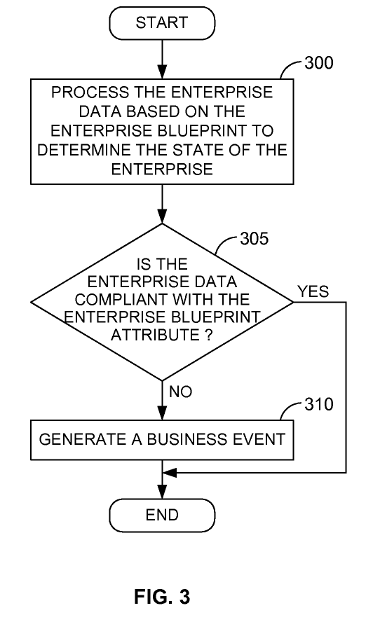

FIG. 3 is a flow diagram for analyzing the enterprise data based on the enterprise blueprint to determine a state of the enterprise according to an embodiment of the invention. At step 300, the enterprise data is processed based on the enterprise blueprint to determine the state of the enterprise. At step 305, the enterprise data is verified for a compliance with the enterprise blueprint attribute. The enterprise blueprint attribute includes a business attribute of the enterprise such as an enterprise goal, an enterprise objective, a business process, an enterprise location, and the business process followed in the enterprise location.

Consider an example, wherein the enterprise data is checked for whether the business process followed is in compliance with the enterprise blueprint attribute business process. If the enterprise data is not compliant with the enterprise blueprint attribute, a business event is generated as depicted in step 310. A business event includes an event such as organizational event, a business process event, a business process step event, a business related external event, and an operational event.

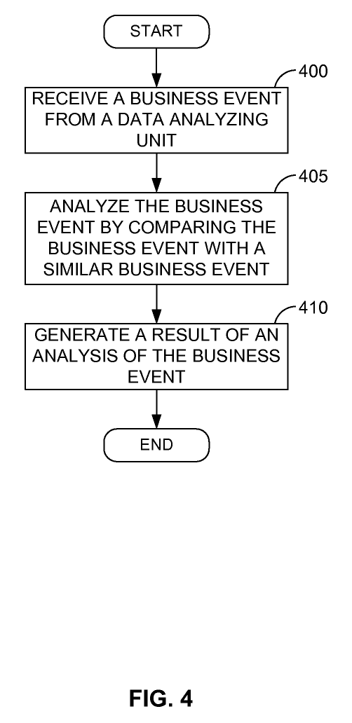

FIG. 4 is a flow diagram for determining an activity to be performed based on a state of an enterprise according to an embodiment of the invention. At step 400, the business event is received from a data analysis unit. At step 405, the business event is analyzed by comparing the business event with a similar business event recorded in an enterprise history database. For example, consider a business event such as a change in selling price of a commodity. This change in selling price of the commodity business event may be analyzed by checking for a similar business event from the enterprise history database. At step 410, a result of an analysis of the business event is generated. The result enables a decision maker to make a decision regarding the activity to be performed based on the state of the enterprise. In an embodiment, the result of the analysis may be generated as a report.

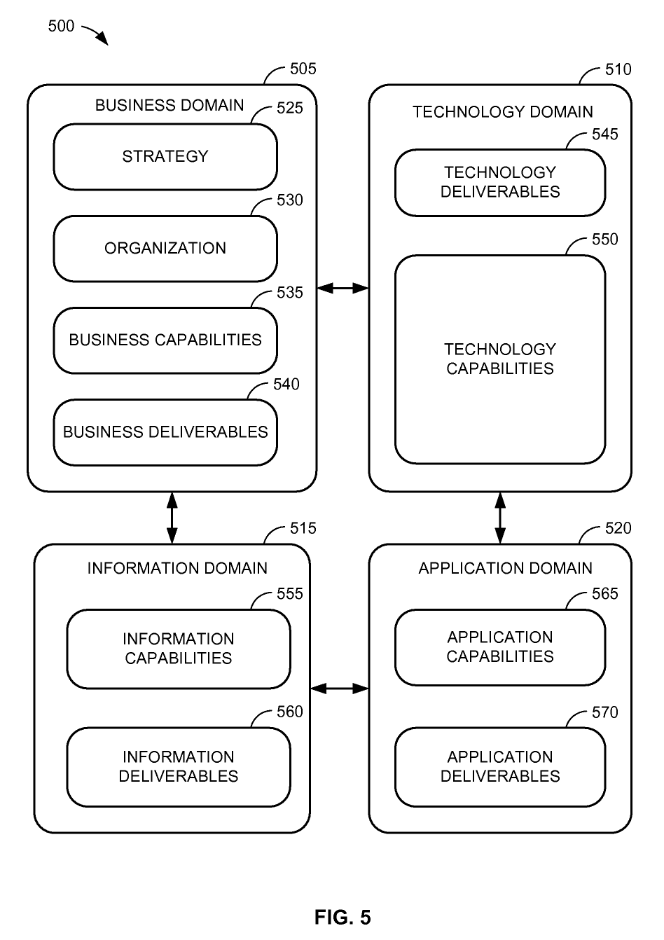

FIG. 5 is a block diagram of an enterprise blueprint according to an embodiment of the invention. Enterprise blueprint 500 defines a business model of the enterprise. Enterprise blueprint 500 is a practice of applying a method for describing a structure and a behavior of processes of the enterprise, information systems, personnel and sub-units of the enterprise, so that they align with the core goals of the enterprise and strategic direction. Enterprise blueprint 500 relates to a practice of business optimization which typically addresses business architecture, process architecture, performance management, and a structure of the enterprise. Enterprise blueprint 500 details all relevant structure within the enterprise including domains such as business domain 505, technology domain 510, information domain 515, and application domain 520. Enterprise blueprint 500 provides a taxonomy that identifies what processes a business performs and detailed information about how the processes are executed. An end product is typically a set of development methods or processes that describe in varying degrees of detail exactly what and how the business operates and what resources are required.

Given these descriptions, decision makers can make informed decisions about where to invest resources, where to realign the goals of the enterprise, the processes of the enterprise, and what policies and procedures will support core business functions. Enterprise blueprint 500 process helps to answer questions like:
Is a current enterprise blueprint 500 supporting and adding value to the enterprise?
How might an enterprise blueprint 500 be modified so that it adds more value to the enterprise?
Based on what a person knows about what the enterprise wants to accomplish in the future, will enterprise blueprint 500 support or hinder that?

Implementing enterprise blueprint 500 generally starts with documenting the strategy and the goals of the enterprise. Implementing enterprise blueprint 500 includes an operating model of the enterprise, which describes how the enterprise may want to operate and requirements for business process standardization and integration. Enterprise blueprint 500 addresses documenting discrete enterprise structural components, typically within four domains such as business domain 505, technology domain 510, information domain 515, and application domain 520.

Business domain 505 addresses business components of the enterprise such as strategy 525, organization 530, business capabilities 535, and business deliverables 540. Strategy 525 addresses business attributes such as goals of the enterprise, objectives of the enterprise, value chain and risk taking capability of the enterprise. A goal of the enterprise may be, for example, to increase sales by 50%, and an objective of the enterprise may be to extend presence of the enterprise on a global level. Organization 530 addresses factors such as location of the enterprise, nature of a unit of the enterprise in the location, role of the enterprise in the location and the concern of the enterprise. Business capabilities 535 addresses factors such as business scenario supported in the enterprise, that is, the way in which a particular business is carried out in the enterprise, a process step of the business scenario, and a configuration of the business scenario. Business deliverables 540 addresses factors such as deliverables of the business, constraints in the business, a gap analysis of a requirement of the business versus actual deliveries. The gap analysis analyzes a gap between the actual deliveries and required deliveries of the business.

Technology domain 510 addresses technology deliverables 545 and technology capabilities 550 of the enterprise. Technology deliverables 545 addresses factors such as technology requirements, constraints faced in fulfilling the technology requirements, a gap analysis of the technology requirements versus actual technology deliverables 545. The gap analysis would enable a person to take corrective actions so as to make the technology deliverables 545 meet the technology requirement.

Technology capabilities 550 include resources such as infrastructure software, application software, a server, a database management system, a local area network, a wide area network, a communication system, and a scalability of hardware and/or software. A performance of the enterprise typically depends on infrastructure capabilities as much as it depends on strategy 525. For example, if the enterprise does not have a good technical infrastructure to maintain finance and accounting aspects of the enterprise, then the enterprise may have to employ people in place of machines or software to do the job which may cost more and consume more time thereby increasing the operational expenditure and decreasing the performance of the enterprise.

Information domain 515 addresses factors such as information capabilities 555 and information deliverables 560. Information capabilities 555 addresses factors such as a metadata and data model capabilities of the enterprise. The metadata is information about data. For example, the metadata about a file may include information such as a file name, an extension of the file, and a size of the file. The metadata is used to speed up searching for resources. In general, a search query using the metadata can save users from performing more complex filter operations manually. It is common for a web browser and media management software to automatically download and locally cache metadata, to improve the speed at which files can be accessed and searched. The metadata may be stored either internally, in the same file as the data, or externally, in a separate file.

A data model is an abstract model that describes how data is represented and used. The data model includes models such as logical data model, conceptual data model, and physical data model. A data model has three main components:
Structural component: The structural component is a collection of data structures which are used to create databases representing entities or objects modeled by a database.
Integrity component: The integrity component is a collection of rules governing constraints placed on the data structures to ensure structural integrity.
Manipulation component: The manipulation component is a collection of operators which can be applied to the data structures, to update and query the data contained in the database.

Information deliverables 560 addresses factors such as information requirements, constraints faced in fulfilling the information requirements, and a gap analysis of the information requirements versus actual information deliverables. The gap analysis would enable a person to take corrective actions so as to make the information deliverables 560 meet the information requirement.

Application domain 520 address factors such as application capabilities 565 and application deliverables 570. Application capabilities 565 describes the application capabilities of the enterprise such as application software, interface between applications such as events, messages, and data flow between applications. The application software may handle enterprise service operations. Application capabilities 565 also includes the capability of the enterprise to have intranet, internet, ecommerce links with parties within and outside the enterprise.

Application deliverables 570 address factors such as application requirements, constraints faced in fulfilling the application requirements, a gap analysis of the application requirements versus actual application deliverables 560. For example, a requirement of the enterprise may be that it needs application software to handle all payroll related details of the enterprise employees. If an existing payroll application software application is not able to meet the requirements, the gap analysis would enable a person to take corrective actions so as to make the payroll application software meet the enterprise requirement.

The enterprise must typically design and implement the processes that ensure continual movement from a current state to a future state, keeping the details current. The future state planning will generally be a combination of one or more of the following:
Closing gaps that are present between a current enterprise strategy and an ability of an information technology part of the enterprise to support it
Closing gaps that are present between a desired future enterprise strategy and the ability of the information technology part of the enterprise to support it
Necessary upgrades and replacements that must be made to the infrastructure using lifecycle management practices for infrastructure and technologies employed, to address ever changing requirements.

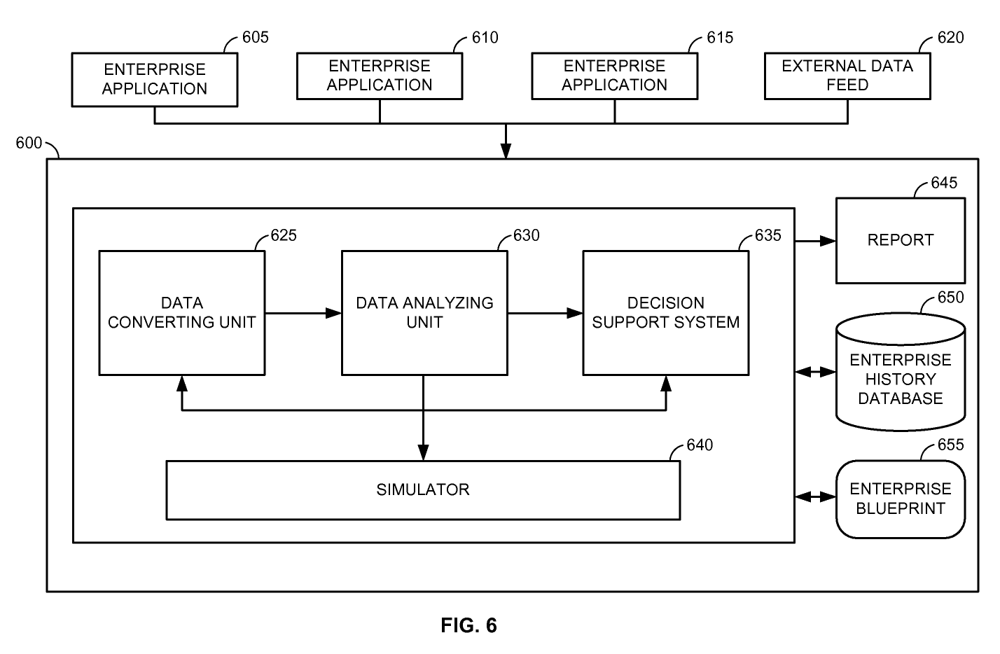

FIG. 6 is a block diagram of an enterprise management system to determine an activity to be performed based on the state of the enterprise according to an embodiment of the invention. Enterprise management system 600 receives data from one or more enterprise applications such as enterprise application 605, enterprise application 610, enterprise application 615 and external data feed 620 in a format that includes extensible markup language (XML). Enterprise application 605 may include an application such as a customer relationship management application, a supplier relationship management application, a supply chain management application, a finance application, and an enterprise resource planning application. After receiving the data from enterprise application 605, enterprise application 610, enterprise application 615 and external data feed 620, data converting unit 625 converts the data to enterprise data based on enterprise blueprint 655.

Converting the data to enterprise data includes consolidation of the data received from enterprise applications such as enterprise application 605, enterprise application 610, enterprise application 615 and external data feed 620 by data converting unit 625. Converting the data also includes identifying the data received based on a metadata of the data. The metadata of the data includes attributes such as an enterprise application identifier, a business process identifier, a business process step identifier, an input data to the business process and an output data of the business process. For example, the enterprise application identifier may be “create sales order”, a business process step identifier may be “create sales order number”, input data may be customer identification and output data may be a sales order. Identifying the data includes identifying various parts of data which belongs to various domains and components of enterprise blueprint 655, that is, the part of the data which belongs to business process in business domain 505 is identified, and the part of the data which belongs to application domain 520 is identified based on the metadata. Data converting unit 625 creates enterprise data from the data in a structure based on enterprise blueprint 655. After creating the enterprise data, the enterprise data is persisted in an instance of enterprise blueprint 655 based on the metadata.

Data analyzing unit 630 analyzes the enterprise data based on enterprise blueprint 655. Data analyzing unit 630 processes the enterprise data based on enterprise blueprint 655 to determine a state of the enterprise. Processing of the enterprise data includes mapping the enterprise data to right components of enterprise blueprint 655 and verifying whether the enterprise data is in compliance with enterprise blueprint 655, that is, whether the enterprise data is overruling an enterprise blueprint attribute. The enterprise data is checked for compliance such as whether a business process followed in the enterprise data is in compliance with the business process of the enterprise defined in business domain 505 of enterprise blueprint 655. The enterprise data may also be checked for compliance such as whether the technology capabilities 550 of the enterprise is in line with the technology capabilities 550 required to produce a specified quantity of a product in the enterprise data. Data analyzing unit 630 may also determine the amount of labor required to produce a specified quantity of the product in the enterprise data based on an attribute of business domain 505 such as organization 530.

Data analyzing unit 630 examines the compliance of the enterprise data with an enterprise blueprint attribute such as an enterprise goal, an enterprise objective, a business process, technical capabilities, application capabilities of the enterprise, an enterprise location, and the business process followed in the enterprise location. Such an analysis would determine the state of the enterprise, such as, how many people are required to produce a specified quantity of a product, what is the amount of raw material that needs to be purchased to produce the specified quantity, what is the amount of money required, whether there is enough money in the enterprise to accept another order from a customer, what would be the profit involved, and what would be the loss involved in a deal. If data analyzing unit 630 finds the enterprise data not complying or overruling the enterprise blueprint attribute, then a business event is generated. The business event includes an event such as an organizational event, a business process event, a business related external event, and an operational event. For example, if a business process specified in the enterprise data is not complying with the business process defined in business domain 505 of the enterprise, a business event is generated. The business event containing particular details of non compliance of the enterprise is passed to decision support system 635.

Decision support system 635 is an information system that supports business and decision-making activities of the enterprise. Decision support system 635 enables decision maker compile useful information from raw data, documents, personal knowledge, and enterprise blueprint 655 to identify and solve problems and make decisions. Decision support system 635 receives the business event from data analyzing unit 630, analyzes the business event and generates a result of the analysis. In an embodiment, the result of the analysis may be generated in a report. The report enables a decision maker to determine an activity to be performed based on the state of the enterprise. When the business event is received, decision support system 635 checks in enterprise history database 650 for any similar business event that may have occurred in the enterprise in the past. Enterprise history database 650 contains information regarding all business events that have occurred and the respective activities performed based on the state of the enterprise in the past. If any similar business event has occurred in the past, decision support system 635 considers the information regarding the activity performed in the situation to generate a report for the result of the analysis. If no similar business events have occurred in the past, decision support system 635 analyzes the enterprise data, the business event, and enterprise blueprint 655 and generates a report that enables a decision maker to determine an activity to be performed. The report also includes information regarding the state of the enterprise.

Simulator 640 determines the state of the enterprise in a “what if” scenario or a situation. In an embodiment, the situation may be a hypothetical situation created by inputting a hypothetical data to enterprise management system 600. The data is converted to enterprise data by data converting unit 625 based on the enterprise blueprint. Data analyzing unit 630 analyzes the enterprise data and generates a business event which is further analyzed by decision support system 635. Decision support system 635 further generates a result of an analysis of the business event. In an embodiment, the result of the analysis is generated as a report. The report may enable a decision maker to determine an activity to be performed based on the state of the enterprise. For example, the state of the enterprise may be determined in a “what if” scenario such as “what if raw materials price increases by a certain percentage?” or “what if an interest rate of a loan increases?” The state of the enterprise in such a situation may be determined by inputting the raw materials price and the interest rate into enterprise management system 600.

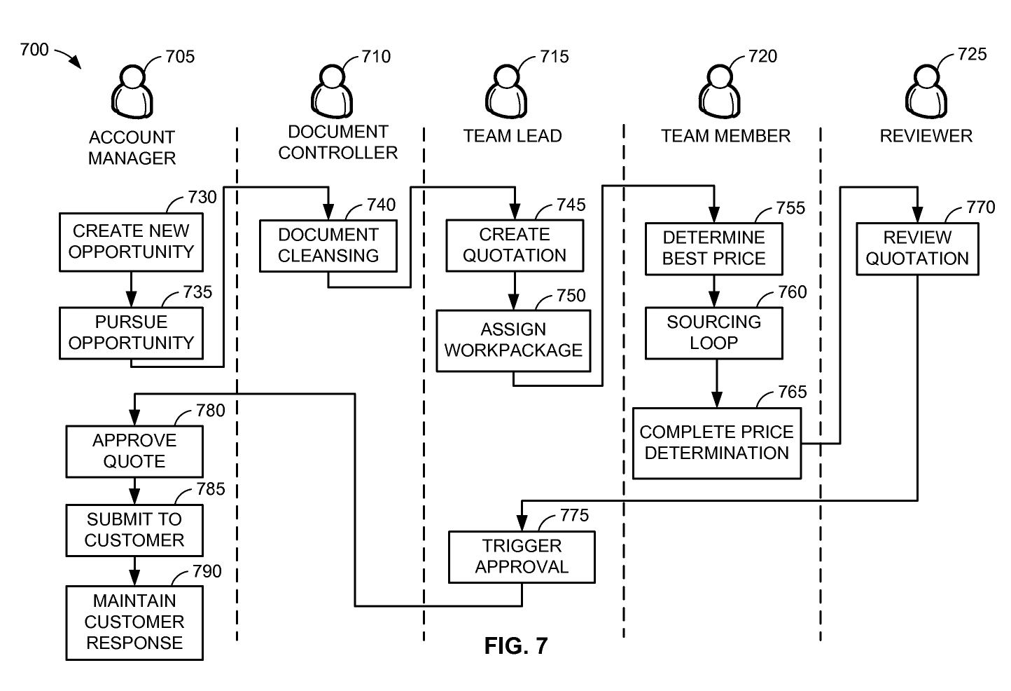

FIG. 7 is a block diagram of an example business scenario executed in an enterprise management system according to an embodiment of the invention. Cost and quotation management 700 business scenario is a scenario for creating a quotation for a product based on a request by a customer. Cost and quotation management 700 business scenario includes a number of business processes such as create new opportunity 730, pursue opportunity 735 and so on, until maintain customer response 790. Each of the business processes further has business process steps (not shown in the figure) that complete the business process. Cost and quotation management 700 business scenario, each of the business processes, and the business process steps are modeled in business domain of enterprise blueprint 655. The other related factors such as database required, applications required, and networking infrastructure for the cost and quotation management 700 business scenario are modeled in technology domain, information domain, and application domain of enterprise blueprint 655.

Create new opportunity 730 business process creates a request for a quotation based on a request from the customer. The request for the quotation is created by account manager 705. A data input to create new opportunity 730 business process includes details such as a name of the customer, a date of quotation, and product details.

Pursue opportunity 735 business process is carried out by account manager 705 to qualify an opportunity based on information such as expected revenue, an opportunity size, and a priority. After which account manager 705, chooses a team and pursues the opportunity using workflow to advise his quote team of incoming opportunities. Pursue opportunity 735 business process and its business process steps are modeled in business domain of enterprise blueprint 655.

Document cleansing 740 business process is carried out by document controller 710 to ensure integrity of a quote data, before a quote team receives the information, that an attached document is correct in both content and format. Upon completion of cleansing, the products are released for further processing by the quote team.

Create quotation 745 business process is carried out by a team lead 715 to create an environment for each quote worksheet. The environment of the quote worksheet includes a decision regarding which cost buckets may be used as well as a priority of cost sources being queried from back-end systems. Cost buckets are equivalent to cost categories such as materials, labor, tooling, and engineering. The cost buckets are customizable on the customer side, that is, if the customer does not require engineering, it can be removed or if membership fees are required, it can be created. Examples of cost sources include purchase orders and contracts.

Assign work package 750 business process is carried out by team lead 715 after the quotation worksheet has been created and to delegate the opportunity to the team as work packages. The work packages will be created and assigned to appropriate team members for further qualification of specific materials of the quote.

Determine best price 755 business process is carried out by team member 720 using the cost sources which team lead 715 determined. Team member 720 will review each material to ensure that a best pricing option is being utilized. If the alternatives are inadequate or require further investigation a manual price may be entered, or sourcing loop 760 business process may be initiated.

Sourcing loop 760 business process is carried out by team member 720 to further qualify prices by requesting quotes from a customer approved vendor list as well as alternative sourcing options.

Complete Price Determination 765 business process is carried out by team member 720 to review the margin costs that were applied upon ensuring the material pricing is correct and the quote worksheet is in order. The margins may have been applied at one of three levels such as material level, cost bucket level and on the level of the entire quote worksheet.

Review quotation worksheet 770 business process is carried out by reviewer 725 to review quotation worksheet submissions from team member 720 to ensure completion. To do this, reviewer 725 reviews the pricing for materials, inspect and evaluate the margins applied at all levels. After making comments regarding their findings, reviewer 725 will submit the quote worksheet to team lead 715 for further approval, before it is returned to account manager 705 for customer evaluation.

Trigger approval loop 775 business process is carried out by team lead 715 upon receipt from reviewer 725 to check a completed quotation and further process it by triggering an approval loop which will send the quote worksheet to account manager 705.

Approve quote 780 business process is carried out account manager 705 after reviewing the final quotation submitted by team lead 715. Account manager 705 has options such as submission of the quote to the customer or request another quote.

Submission to a customer 785 business process is carried out by account manager 705 to provide the quotation to the customer. Each enterprise has their own way to send their quotations to their customers. By defining a download of quote information as a user setting, the application allows for greater flexibility for account manager 705 to decide what to or not to provide to the customer.

Maintain customer response 790 business process is carried out by account manager 705 to maintain the status of customer response which includes either a win or a loss or a re-quote based upon the customer response. This status allows for deeper analysis of the quotation process and resulting business opportunities. This information will then be available for all reporting functions.

All business processes and business process steps described above including other details such as material pricing, labor required, tooling required which are part of technical domain, and rules for pricing are initially modeled in enterprise blueprint 655 of enterprise management system 600. When cost and quotation management 700 business scenario is executed in enterprise management system 600, data from various business processes of various enterprise applications such as customer relationship management for customer data, supplier relation management for raw material supplier data, material management for material data, finance application for financial data are received by data converting unit 625. The data is converted to enterprise data based on enterprise blueprint 655. Data analyzing unit 630 analyzes the enterprise data by verifying whether the business processes such as create new opportunity 730, pursue opportunity 735 and so until maintain customer response 790 in cost and quotation management 700 business scenario follow the business processes modeled in enterprise blueprint 655. Data analyzing unit 630 also checks whether the pricing of the material in the quote follows the business process defined in enterprise blueprint 655. If any of the business process is found to overrule the business process defined in enterprise blueprint 655, then a business event is generated by data analyzing unit 630.

For example, if reviewer 725 in review quotation 770 business process does not realize that a supplier of raw materials for the product for which reviewer 725 is reviewing the price quotation, has filed for bankruptcy, then there is a huge amount of risk involved as the enterprise may not be able to deliver to customer because of uncertainty in supply of the raw materials from the supplier. In such a case, data analyzing unit 630 recognizes this event by analyzing the enterprise data based on enterprise blueprint 655 and generates a business event. Decision support system 635 may analyze the business event by checking for a similar business event in enterprise history database 650. If decision support system 635 finds a similar business event in enterprise history database 650, the activity performed by a decision maker in such a case is typically considered for generating a result of an analysis of the business event. For example, decision support system 635 may find that in a similar situation, the quotation process was halted. If decision support system 635 does not find a similar business event in enterprise history database 650, decision support system 635 may also analyze the business event on its own based on enterprise blueprint 655. In such a case, a result of an analysis of the business event generated by decision support system 635 may suggest halting the quotation process or to find a new supplier. The result of the analysis generated by decision support system 635 typically contains both the analysis of decision support system 635 and the activity performed by the decision maker in a similar situation. In an embodiment, the similar situation may have occurred in the past and the activity performed by the decision maker in the similar situation is persisted in enterprise history database 650. In an embodiment, the result of the analysis may be generated in a report. The report enables the decision maker to determine the activity to be performed accordingly.

In another business scenario, account manager 705 may want to simulate a replacement of the raw materials from the bankrupt supplier with raw materials from other suppliers and evaluate the effect on factors such as cost, delivery time, quality, and customer satisfaction. These business scenarios may not be implemented without enterprise management system 600 since each business process step may be on a different system, some of which are on a premise while others are services hosted by other enterprises and therefore there may be no other source that can govern the complete scenario on an enterprise level.

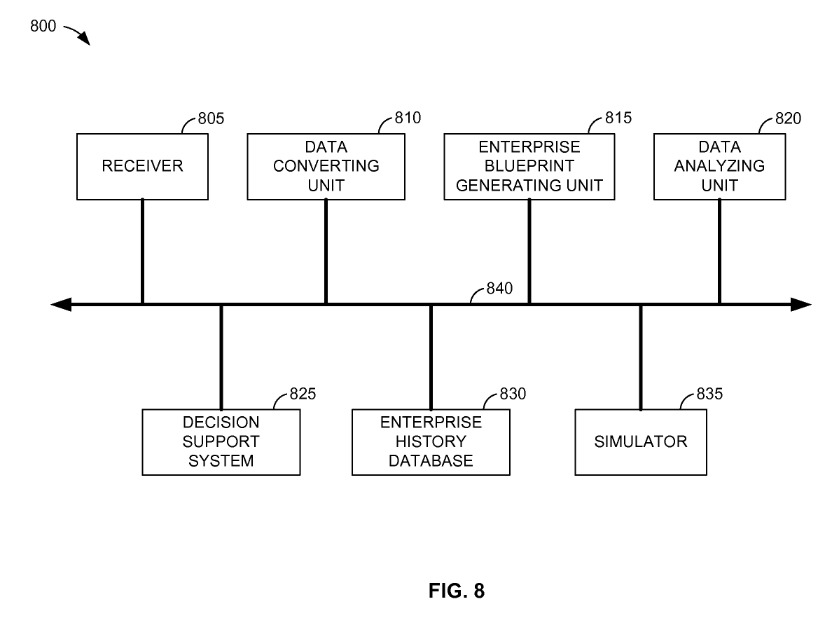

FIG. 8 is a block diagram illustrating various components of a system for managing an enterprise according to an embodiment of the invention. Receiver 805, data converting unit 810, enterprise blueprint generating unit 815, data analyzing unit 820, decision support system 825, enterprise history database 830 and simulator 835 communicate with each other via system bus 840 in enterprise management system 800. Receiver 805 receives data from an enterprise application in a format that includes XML. The data is converted to enterprise data by data converting unit 810 based on an enterprise blueprint. The enterprise blueprint is generated by enterprise blueprint generating unit 815. The enterprise blueprint defines a business model of the enterprise.

The enterprise data is analyzed by data analyzing unit 820 for a compliance with an enterprise blueprint attribute. If the enterprise data is not compliant with the enterprise blueprint attribute, that is, if the enterprise data is overruling the business model defined in the enterprise blueprint, a business event is generated. Decision support system 825 analyzes the business event by searching enterprise history database 830 for a similar business event in the past. Decision support system 825 generates a result of the analysis which contains the state of the enterprise for the particular business event and enables a decision maker to determine an activity to be performed in the case of the business event. Simulator 835 simulates a “what if” scenario to determine a state of the enterprise in a situation based on data input to enterprise management system 800.

Embodiments of the invention may include various steps as set forth above. The steps may be embodied in machine-executable program code which causes a general-purpose or special-purpose processor to perform certain steps. Alternatively, these steps may be performed by specific hardware components that contain hardwired logic for performing the steps, or by any combination of programmed computer components and custom hardware components.

Embodiments of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or any other type of machine-readable media suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims which follow.

What is claimed is:

1. A method, comprising:
receiving data from an enterprise application of an enterprise;
converting the data into enterprise data based on an enterprise blueprint;
analyzing the enterprise data based on the enterprise blueprint to determine a state of the enterprise; and
determining an activity to be performed based on the state of the enterprise.

2. The method in claim 1, wherein converting the data into the enterprise data comprises:
identifying a type of the data based on a metadata of the data;
constructing the enterprise data from the data, wherein a structure of the enterprise data is based on the enterprise blueprint; and
persisting the enterprise data in an instance of the enterprise blueprint based on the metadata.

3. The method in claim 1, wherein analyzing the enterprise data comprises:
processing the enterprise data in the instance of the enterprise blueprint to determine the state of the enterprise;
verifying a compliance of the enterprise data with an enterprise blueprint attribute; and
generating a business event if the enterprise data is not compliant with the enterprise blueprint attribute.

4. The method in claim 1, wherein determining the activity to be performed comprises:
receiving a business event from a data analysis unit;
analyzing the business event by comparing the business event with a similar business event recorded in an enterprise history database; and
generating a result of an analysis of the business event.

5. The method in claim 4 further comprising persisting the business event and an activity performed in the enterprise history database.

6. The method in claim 1, wherein the enterprise blueprint comprises defining a business model of the enterprise by a mapping between domains of the enterprise.

7. The method in claim 3, wherein the enterprise blueprint attribute comprises an attribute selected from a group consisting of an enterprise goal, an enterprise objective, a business process, an enterprise location, and the business process followed in the enterprise location.

8. The method in claim 3, wherein the business event comprises an event selected from a group consisting of an organizational event, a business process event, a business related external event, and an operational event.

9. The method in claim 1, wherein the state of the enterprise comprises a business attribute selected from a group consisting of a net profit of the enterprise, a net loss of the enterprise, an operational expenditure of the enterprise, an operational stability of the enterprise, and an effect of a market on the enterprise.

10. The method in claim 1 further comprising simulating a business scenario based on the enterprise data and the enterprise blueprint to determine the state of the enterprise.

11. The method in claim 1, wherein receiving the data from the enterprise application comprises receiving the data in a format that includes an extensible markup language (XML).

12. The method in claim 1, wherein the enterprise application comprises an application selected from a group consisting of a customer relationship management application, a supplier relationship management application, a supplier relationship management application, a finance application, and an enterprise resource planning application.

13. A system, comprising:
a receiver to receive data from an enterprise application of an enterprise;
a data converting unit electronically coupled to the receiver to convert the data into enterprise data according to an enterprise blueprint;
a data analyzing unit electronically coupled to the data converting unit to analyze the enterprise data based on the enterprise blueprint to determine a state of the enterprise; and
a decision support system electronically coupled to the data analyzing unit to determine an activity to be performed based on the state of the enterprise.

14. The system in claim 13 further comprising, an enterprise history database electronically coupled to a system bus to persist business events and an activity performed based on the state of the enterprise.

15. The system in claim 13 further comprising, an enterprise blueprint generating unit electronically coupled to a system bus to generate the enterprise blueprint that defines a business model of the enterprise.

16. The system in claim 13 further comprising, a simulator electronically coupled to a system bus to simulate a hypothetical situation based on a hypothetical enterprise data and a hypothetical enterprise blueprint to determine the state of the enterprise.

17. The system in claim 13 wherein the receiver, the data converting unit, the data analyzing unit, and the decision support system are electronically coupled to a system bus.

18. An article of manufacture, comprising:
a machine readable medium having instructions which when executed by a machine cause the machine to:
receive data from an enterprise application of an enterprise;
convert the data into enterprise data according to an enterprise blueprint;
analyze the enterprise data based on the enterprise blueprint to determine a state of the enterprise; and
determine an activity to be performed based on the state of the enterprise.

19. The article of manufacture in claim 18, wherein the machine readable medium provides instructions, which when executed by a machine cause the machine to
identify a type of the data based on a metadata of the data;
construct the enterprise data from the data, wherein a structure of the enterprise data is based on the enterprise blueprint; and
persist the enterprise data in an instance of the enterprise blueprint based on the metadata.

20. The article of manufacture in claim 18, wherein the machine readable medium provides instructions, which when executed by a machine cause the machine to
process the enterprise data in the instance of the enterprise blueprint to determine the state of the enterprise;
verify a compliance of the enterprise data with an enterprise blueprint attribute; and
generate a business event in case of non-compliance of the enterprise data with the enterprise blueprint attribute.
